(19) United States
(12) Patent Application Publication
(10) Pub. No.: US 2023/0225488 A1
(43) Pub. Date: Jul. 20, 2023

(54) Hammer Holder

(71) Applicants: Constantine Michael Gioia, West Columbia, SC (US); Valeska N. Gioia, West Columbia, SC (US)

(72) Inventors: Constantine Michael Gioia, West Columbia, SC (US); Valeska N. Gioia, West Columbia, SC (US)

(21) Appl. No.: 17/825,418

(22) Filed: May 26, 2022

Related U.S. Application Data
(60) Provisional application No. 63/300,962, filed on Jan. 19, 2022.

(51) Int. Cl. A45F 5/02

(52) U.S. Cl. CPC A45F 5/021; A45F 2200/0575; B25H 3/006

(57) ABSTRACT

The hammer holder is a device used to secure a hammer to a user when not in use. The hammer holder comprises a rigid conduit attached to a mounting panel. The rigid conduit further comprises an expanded aperture, an elongated slot, and a constricted aperture. The expanded aperture and the constricted aperture are oppositely and terminally positioned on the rigid conduit, connected by the elongated slot. The placement and dimensions of the components of the rigid conduit allow a hammer bell and neck to be inserted at the expanded aperture, slid through the elongated slot, and held at the constricted aperture.

### FIELD OF THE INVENTION

The present invention relates generally to a hammer holder. More specifically, the holder provides a cylindrical-shaped holder that can be mounted on a tool belt using an attachment plate.

### BACKGROUND OF THE INVENTION

Hammers have many uses, building construction, general carpentry, assembling furniture to name a few. Hammer holders are designed to secure the hammer to one's person, on a tool belt or apron and allow hands to be free till hammer is needed. Further, the hammer holder can be used while working in a location where there is no place to set the hammer down, such as on a ladder, lift, etc.

An objective of the present invention is to make the process of securing and or deploying a hammer as quick, simple, and easy as possible. Another objective of the present invention is to provide a hammer holder that can be mounted on the tool belt. The hammer holder provides a cylindrical-shaped holder that the user can secure the hammer. Utilizing the present invention, the hammer can be available anywhere and can be carried around without having the user hold the hammer. Additional features and benefits are further discussed in the sections below.

### BRIEF DESCRIPTION OF THE DRAWINGS

FIG. 1 is a top front isometric view of the hammer holder of the present invention.

FIG. 2 is a rear bottom isometric view of the hammer holder of the present invention.

FIG. 3 is a top front exploded perspective view of the hammer holder of the present invention.

FIG. 4 is a top front perspective view of an alternative embodiment of the hammer holder the present invention wherein the invention is configured for a left-handed use.

FIG. 5 is a right-side elevation view of the hammer holder of the present invention.

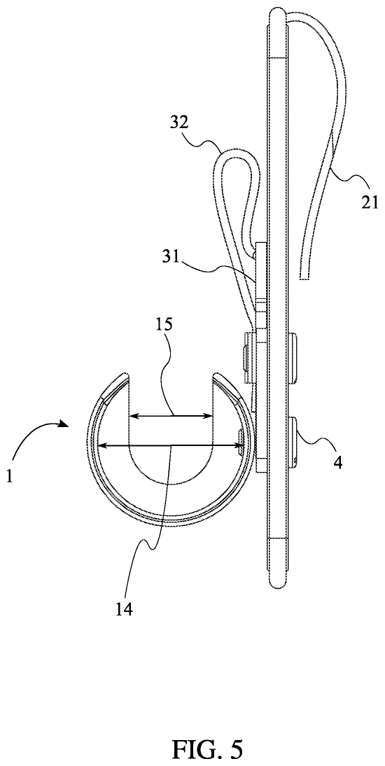

FIG. 6 is a perspective view of the hammer holder of the present invention, showing an exemplary hammer entering the rigid conduit.

FIG. 7 is a perspective view of the hammer holder of the present invention, showing an exemplary hammer resting in the constricted aperture and the blocking assembly gate engaged with the rigid conduit.

FIG. 8 is a perspective view of the hammer holder of the present invention, showing an exemplary hammer resting in the constricted aperture and the blocking assembly gate engaged with the rigid conduit.

FIG. 9 is a side elevation view of an exemplary hammer used with the present invention.

### DETAIL DESCRIPTIONS OF THE INVENTION

All illustrations of the drawings are for the purpose of describing selected versions of the present invention and are not intended to limit the scope of the present invention.

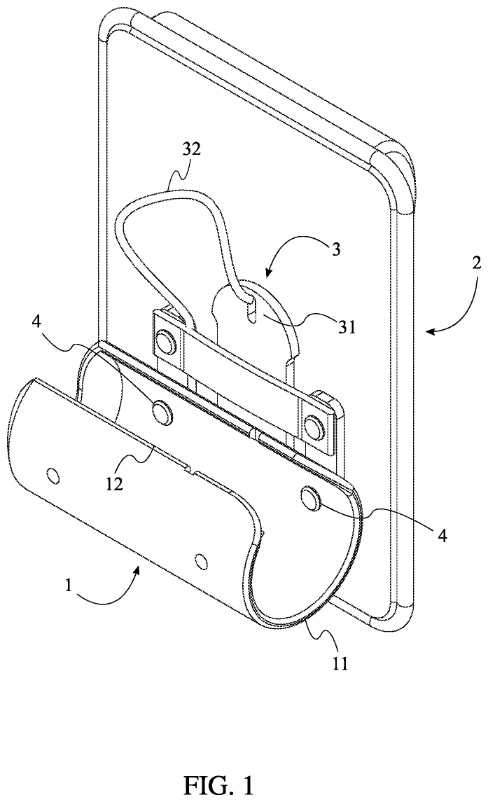

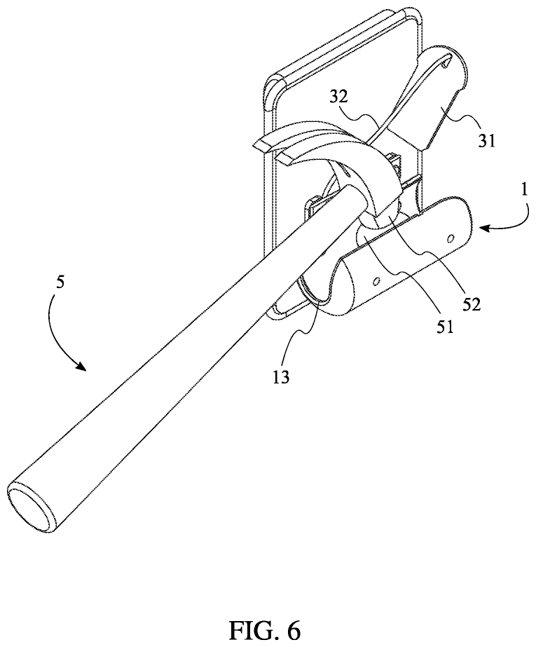

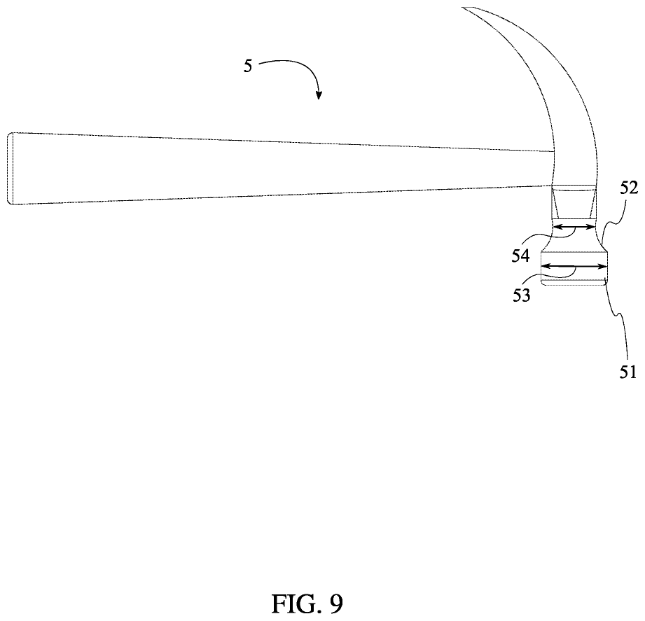

The present invention provides a hammer holder. As shown in FIG. 6-8, a user can secure a hammer 5 onto the present invention. The present invention allows the user to carry the hammer 5 anywhere and have it ready to use. Referring to FIG. 9, traditional hammers 5 have many parts such as the face, bell 51, neck 52, cheek, claw, and handle. Unlike a conventional hammer holder, the present invention does not work with the hammer handle but with the bell 51, face, and neck 52. Utilizing the present invention, the hammer 5 can be secured or deployed quickly using all-natural hand movements. Referring to FIG. 1, in a preferred embodiment, the present invention comprises a rigid conduit 1, a mounting panel 2, and at least one releasable fastener 4. The rigid conduit 1 accommodates the hammer 5. The holder is assembled with the mounting panel 2 using the at least one releasable fastener 4 and the assembly can be mounted on a work belt. In the other embodiments, the holder can be mounted on a tool apron or other garment.

The rigid conduit 1 provides a hollow cylindrical structure. The front of the rigid conduit 1 includes an expanded aperture 11, while the rear of the rigid conduit 1 includes a constricted aperture 13. The rigid conduit 1 comprises an elongated slot 12 that uniformly runs on top of the rigid conduit 1 from the expanded aperture 11 at the front to the constricted aperture 13 at the rear of the rigid conduit 1. The constricted aperture 13 is slightly rounded. The elongated slot 12 runs down the rear, connecting to the rounded constricted aperture 13. The constricted aperture 13 is where the hammer's neck 52 rests when the hammer is secured. Further, the rigid conduit 1 comprises a plurality of attachment holes on the middle portion of the left and right surfaces of the rigid conduit 1. The plurality of attachment holes allows the rigid conduit 1 to be assembled with the mounting panel 2 on the desired side based on the user's preferences. In the preferred embodiment, all surfaces on the rigid conduit 1 are smooth, all edges are rounded. The holder can be adjusted for right- or left-handed users. As seen in FIG. , the holder is positioned for a left-handed user. The rigid conduit 1 may be made of, but is not limited to, PVC or Polypropylene material. In the preferred embodiment, the holder can hold the hammers from 12oz to 28oz. For larger hammers, a larger elongated slot 12 and expanded aperture 11 is required and the reverse for smaller hammers.

In order to correctly accommodate the hammer 5 in the rigid conduit 1, the dimensions of the components of the rigid conduit 1 are specifically tailored to match the dimensions of the components of the hammer 5 being used. Specifically, the expanded aperture 11 has an expanded aperture diameter 14 and the constricted aperture 13 has a constricted aperture diameter 15. The constricted aperture diameter 15 is generally the same length as the width of the elongated slot 12 and is smaller than the expanded aperture diameter 14. The hammer 5 has a bell 51 with a bell diameter 53 and a neck 52 with a neck diameter 54. In order for the hammer 5 to correctly engage with the rigid conduit 1, the bell diameter 53 must be less than the expanded aperture diameter 14 and greater than the constricted aperture diameter 15, while the neck diameter 54 must be less than the constricted aperture diameter 54. This dimensional relationship between the hammer 5 and the rigid conduit 1 allows the hammer 5 to slide into the rigid conduit 1 without sliding out the back end of the rigid conduit 1.

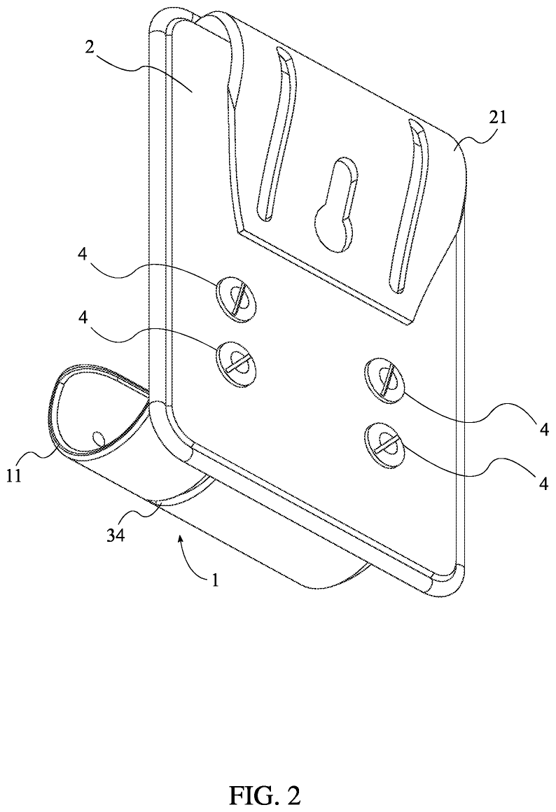

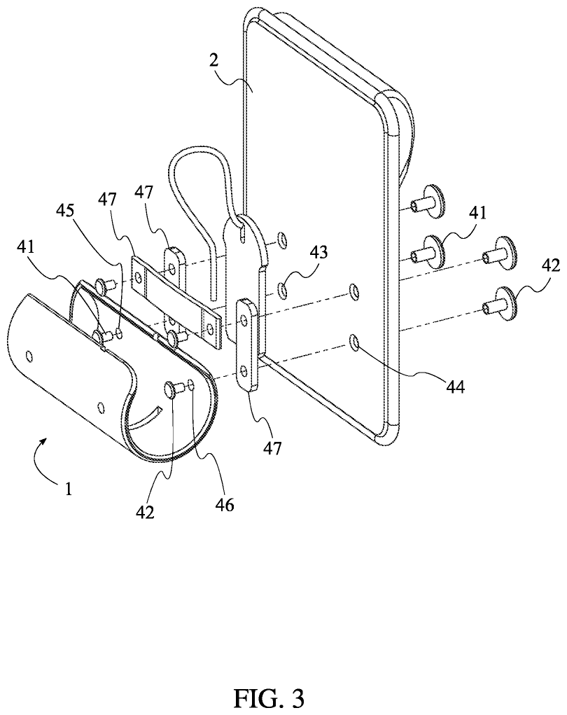

As can be seen in FIG. 3, the mounting panel 2 provides a flat rectangular structure, although any desired shape and structure may be used. In the preferred embodiment, the mounting panel 2 comprises a plurality of attachment apertures. The plurality of attachment apertures is located on the lower portion of the mounting panel 2. The plurality of attachment holes and the plurality of attachment apertures allow the mounting panel 2 to be assembled with the rigid conduit 1 using the at least one releasable fastener 4. In the preferred embodiment, the mounting panel 2 is made of, but not limited to, plastic, leather, canvas, or other durable material. As shown in FIG. 2, a belt clasp 21 may be attached to the mounting panel 2 opposite the rigid conduit 1. In the preferred embodiment, the belt clasp 21 is a simple clip configured to slide over a belt or other article of clothing, securing the hammer holder to the user. In other embodiments, the belt clasp 21 may be a slot configured for a belt to slide through or any other means of attaching the invention to a user.

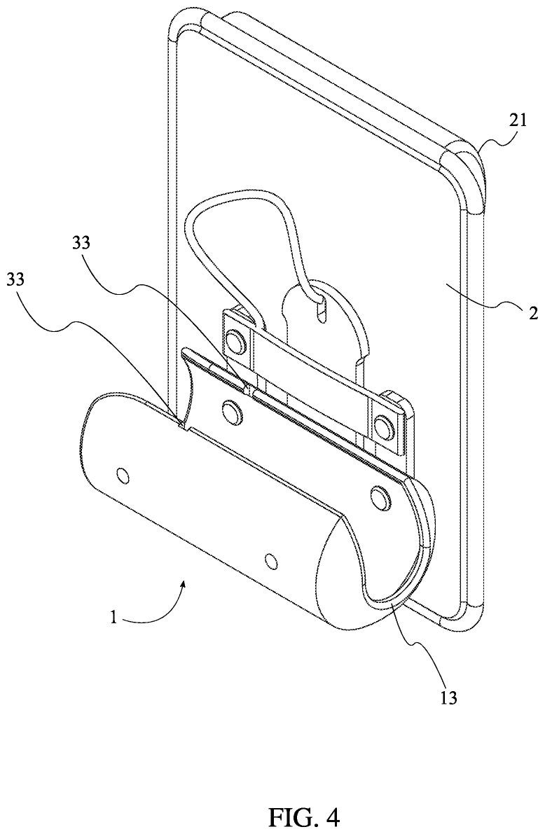

As can be seen in FIG. 1-4, the at least one releasable fastener 4 secures the assembly of the holder and the attachment plate. In the preferred embodiment, the at least one releasable fastener 4 is, but not limited to, Chicago fasteners. The at least one releasable fastener 4 is preferably easily removable to allow adjustment of the holder between a left-handed and right-handed orientation. The at least one releasable fastener 4 provides a flat cylindrical structure, although any desired structure may be used.

In one embodiment of the present invention shown in FIG. 3, the rigid conduit 1 connects to the mounting panel 2 with the at least one releasable fastener 4 as follows. The at least one releasable fastener 4 comprises a first fastener 41 and a second fastener 42. The plurality of attachment holes on the rigid conduit 1 comprises a first hole 45 and a second hole 46 and the plurality of attachment apertures on the mounting panel 2 comprises a first aperture 43 and a second aperture 44. In this system of two fasteners, the first fastener 41 is positioned into the first hole 45, the second fastener 42 is positioned into the second hole 46, the first fastener 41 is further positioned into the first aperture 43, and the second fastener 42 is further positioned into the second aperture 44. The first hole 45 and the second hole 46 may be positioned on either side of the rigid conduit 1 or may be positioned through both sides of the rigid conduit 1, allowing the rigid conduit 1 to be attached to the mounting panel 2 in a left-handed or right-handed orientation. In some embodiments, a plurality of reinforcement tabs 47 may be placed between the rigid conduit 1 and the mounting panel 2, further secured by the at least one releasable fastener 4, to provide structural stability to the connection.

In some embodiments of the present invention, the hammer holder includes a blocking assembly 3. The purpose of the blocking assembly is to ensure that the hammer 5 cannot accidentally fall out of the rigid conduit 1. The blocking assembly 3 comprises a gate 31 and a lanyard 32. The gate 31 is secured to the hammer holder by the lanyard 32, with the lanyard connecting at one end to the gate 31, and at the opposite end to a fixed component of the hammer holder. This fixed component of the hammer holder may be the plurality of reinforcement tabs 47, the mounting panel 2, the belt clasp 21, the rigid conduit 1, or any other component of the present invention. The gate 31 connects with the rigid conduit 1 to block the interior channel of the rigid conduit 1, keeping the hammer from being able to be removed from the rigid conduit 1 while the gate 31 is in place. To better accommodate the blocking assembly, the rigid conduit 1 may further comprise a first locking formation 33 and a second locking formation 34. In the preferred embodiment, the first locking formation 33 is a narrow slot at the bottom of the rigid conduit 1 and the second locking formation 34 is a pair of slits opposite each other on the elongated slot 12. In this embodiment, the gate 31 is wider at the top than the bottom, allowing the bottom of the gate 31 to be inserted into the first locking formation 33, while the top of the gate does not pass through the second locking formation 34.

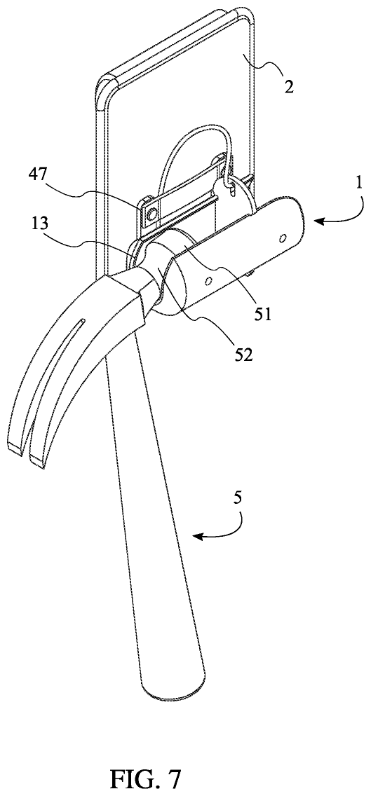

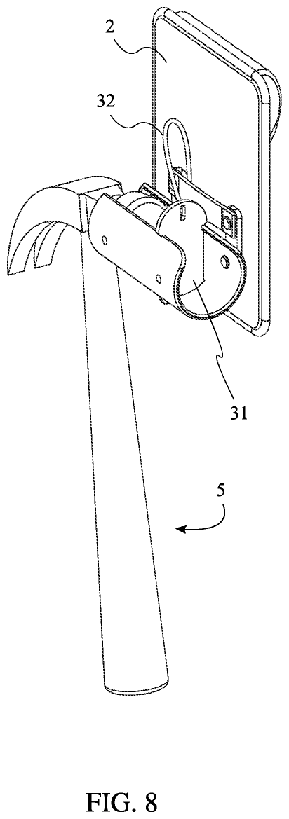

The procedure for securing the hammer 5 utilizing the present invention is as follows. Secure the holder to the user's preferred side of the waist and hold the hammer 5 by grasping the hammer's handle. Both the holder and the hammer are oriented in a horizontal position. The hand holding the hammer is used to locate the elongated slot 12 and expanded aperture 11 of the rigid conduit 1. As can be seen in FIG. 6, the hammer's neck 52, bell 51, and face are inserted into the elongated slot 12 and expanded aperture 11 of the rigid conduit 1. The hammer's neck 52 is the only part of the hammer 5 that fits the elongated slot 12. The hammer 5 is moved backward until the hammer's bell 51 contacts the rear end at the constricted aperture 13. Once the hammer 5 is situated in the rigid conduit 1, the blocking assembly 3 may be engaged with the rigid conduit 1. Since the bell 51 of the hammer 5 is larger than the elongated slot 12 and constricted aperture 13 of the rigid conduit 1, the hammer 5 stays in the rigid conduit 1 and pivots down to a vertical position when not held by the user. As can be seen in FIG. 7-8, the neck 52 of the hammer 5 rests securely on the constricted aperture 13 of the rigid conduit 1.

The procedure for deploying the hammer 5 utilizing the present invention is as follows. If the blocking assembly 3 is in place, the blocking assembly 3 is disconnected from the rigid conduit 1. The hammer 5 is grabbed by the handle and tilted so that the neck 52 of the hammer 5 moves from the constricted aperture 13 to the elongated slot 12. The hammer is then moved forward, sliding the neck 52 through the elongated slot 12 from the constricted aperture 13 to the expanded aperture 11, releasing the hammer from the rigid conduit 1.

Although the invention has been explained in relation to its preferred embodiment, it is to be understood that many other possible modifications and variations can be made without departing from the spirit and scope of the invention.

What is claimed is:

1. A hammer retention apparatus comprising:
a rigid conduit;
a mounting panel;
the rigid conduit further comprising an expanded aperture, an elongated slot, and a constricted aperture;
the expanded aperture being terminally positioned onto the rigid conduit;
the constricted aperture being terminally positioned onto the rigid conduit, opposite the expanded aperture; and
the elongated slot connecting between the expanded aperture and the constricted aperture.

2. The hammer retention apparatus as claimed in claim 1 comprising:
at least one releasable fastener; and
the at least one releasable fastener being mounted between the rigid conduit and the mounting panel.

3. The hammer retention apparatus as claimed in claim 2 comprising:
the at least one releasable fastener being a first fastener and a second fastener;
the mounting panel comprising a first aperture and a second aperture;
the rigid conduit comprising a first hole and a second hole;
the first fastener being positioned into the first hole;
the second fastener being positioned into the second hole;
the first fastener being positioned into the first aperture; and
the second fastener being positioned into the second aperture.

4. The hammer retention apparatus as claimed in claim 1 comprising:
a blocking assembly; and
the blocking assembly being removably positioned into the rigid conduit across the elongated slot.

5. The hammer retention apparatus as claimed in claim 5 comprising:
the blocking assembly comprising a gate, a lanyard, a first locking formation, and a second locking formation;
the lanyard being connected between the gate and the mounting panel;
the first locking formation being positioned adjacent to the elongated slot;
the second locking formation being positioned offset from the elongated slot about the rigid conduit; and
the gate being slidably mounted into the first locking formation and the second locking formation.

6. The hammer retention apparatus as claimed in claim 1 comprising:
a belt clasp; and
the belt clasp being positioned onto the mounting panel, opposite to the rigid conduit.

7. The hammer retention apparatus as claimed in claim 1 comprising:
a plurality of reinforcement tabs;
the plurality of reinforcement tabs being distributed between the rigid conduit and the mounting panel; and
the at least one releasable fastener being positioned through one of the plurality of reinforcement tabs.

8. A hammer retention apparatus comprising:
a rigid conduit;
a mounting panel;
a belt clasp;
at least one releasable fastener;
the at least one releasable fastener being mounted between the rigid conduit and the mounting panel; and
the belt clasp being positioned onto the mounting panel, opposite to the rigid conduit.

9. The hammer retention apparatus as claimed in claim 1 comprising:
the rigid conduit further comprising an expanded aperture, an elongated slot, and a constricted aperture;
the expanded aperture being terminally positioned onto the rigid conduit;
the constricted aperture being terminally positioned onto the rigid conduit, opposite the expanded aperture and
the elongated slot connecting between the expanded aperture and the constricted aperture.

10. The hammer retention apparatus as claimed in claim 1 comprising:
a blocking assembly;
the blocking assembly being removably positioned into the rigid conduit across the elongated slot;
the blocking assembly comprising a gate, a lanyard, a first locking formation, and a second locking formation;
the lanyard being connected between the gate and the mounting panel;
the first locking formation being positioned adjacent to the elongated slot;
the second locking formation being positioned offset from the elongated slot about the rigid conduit; and
the gate being slidably mounted into the first locking formation and the second locking formation.

11. The hammer retention apparatus as claimed in claim 1 comprising:
the at least one releasable fastener being a first fastener and a second fastener;
the mounting panel comprising a first aperture and a second aperture;
the rigid conduit comprising a first hole and a second hole;
the first fastener being positioned into the first hole;
the second fastener being positioned into the second hole;
the first fastener being positioned into the first aperture; and
the second fastener being positioned into the second aperture.

12. The hammer retention apparatus as claimed in claim 1 comprising:
a plurality of reinforcement tabs;
the plurality of reinforcement tabs being distributed between the rigid conduit and the mounting panel; and
the at least one releasable fastener being positioned through one of the plurality of reinforcement tabs.

13. A hammer retention apparatus comprising:
a rigid conduit;
a mounting panel;
a belt clasp;
a blocking assembly;
the rigid conduit further comprising an expanded aperture, an elongated slot, and a constricted aperture;
the expanded aperture being terminally positioned onto the rigid conduit;
the constricted aperture being terminally positioned onto the rigid conduit, opposite the expanded aperture;
the elongated slot connecting between the expanded aperture and the constricted aperture;
the belt clasp being positioned onto the mounting panel, opposite to the rigid conduit;
the blocking assembly being removably positioned into the rigid conduit across the elongated slot;
the blocking assembly comprising a gate, a lanyard, a first locking formation, and a second locking formation;
the lanyard being connected between the gate and the mounting panel;
the first locking formation being positioned adjacent to the elongated slot;
the second locking formation being positioned offset from the elongated slot about the rigid conduit; and
the gate being slidably mounted into the first locking formation and the second locking formation.

14. The hammer retention apparatus as claimed in claim 1 comprising:
at least one releasable fastener;
the at least one releasable fastener being mounted between the rigid conduit and the mounting panel;
the at least one releasable fastener being a first fastener and a second fastener;
the mounting panel comprising a first aperture and a second aperture;
the rigid conduit comprising a first hole and a second hole;
the first fastener being positioned into the first hole;
the second fastener being positioned into the second hole;
the first fastener being positioned into the first aperture; and
the second fastener being positioned into the second aperture.

15. The hammer retention apparatus as claimed in claim 1 comprising:
a plurality of reinforcement tabs;
the plurality of reinforcement tabs being distributed between the rigid conduit and the mounting panel; and
the at least one releasable fastener being positioned through one of the plurality of reinforcement tabs.
